(19) United States
(12) Patent Application Publication
(10) Pub. No.: US 2026/0148115 A1
(43) Pub. Date: May 28, 2026

(54) COMBINING MACHINE LEARNING AND GENERATIVE ARTIFICIAL INTELLIGENCE FOR EXPLAINABLE PREDICTIONS

(71) Applicant: ServiceNow, Inc., Santa Clara, CA (US)

(72) Inventors: Fabio Casati, Pedrinate (CH); Yichang Chen, Mountain View, CA (US); Rohit Dikshit, Fremont, CA (US); Daniel Davidson, Exeter (GB); Lijun Yin, London (GB); Andrew Och, Camberley (GB); Deepak Garg, Meerut (IN); Apeksha Deval, Hyderabad (IN)

(21) Appl. No.: 18/975,247

(22) Filed: Dec. 10, 2024

(30) Foreign Application Priority Data
Nov. 22, 2024 (IN) 202411091046

(51) Int. Cl. G06N 5/045; G06N 3/0475

(52) U.S. Cl. CPC G06N 5/045; G06N 3/0475

(57) ABSTRACT

Embodiments of the subject technology relate to systems, methods, and computer-readable media for using an LLM to generate an explanation of an output of an ML model. An input indicative of a scenario associated with an enterprise can be obtained. An output associated with the scenario can be generated based on the input via an ML model. An explanation of the output can be inferred by an LLM based on data associated with the ML model. A graphical representation of the output and the explanation can be generated.

### CROSS REFERENCE TO RELATED APPLICATIONS

This patent application claims the benefit and priority of Indian Provisional Patent Application No. 202411091046, filed with the Office of the Controller General of Patents, Designs and Trade Marks on Nov. 22, 2024, entitled “COMBINING MACHINE LEARNING AND GENERATIVE ARTIFICIAL INTELLIGENCE FOR EXPLAINABLE PREDICTIONS,” the content of which is incorporated by reference in its entirety.

### BACKGROUND

### 1. Technical Field

The present disclosure generally relates to explaining an output of a machine learning (ML) model, and more specifically to using a large language model (LLM) to generate an explanation of an output of an ML model.

### 2. Introduction

An entity may use a machine learning model to gain insights and predictions about different scenarios. However, the output of this machine learning model can be in a form that is difficult for an entity to interpret. Further, the output of this machine learning model can lack information from which the entity can gather meaningful insight. For example, a machine learning model can be applied to identify specific risk levels associated with change requests made by an enterprise, e.g., as part of change management. As follows, the specific risk levels can be presented to the enterprise without any context associated with the risk levels or information describing the circumstances that led to the classification at the specific risk levels.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1A illustrates a diagram of an example cloud computing architecture, according to some examples of the present disclosure;

FIG. 1B is a block diagram illustrating an example network architecture that can be used to implement one or more embodiments, components, devices, nodes, systems, instances, and/or portions of the example cloud computing architecture, according to some examples of the present disclosure;

FIG. 2 illustrates a schematic diagram of an architecture for inferring an explanation of an ML model output to a scenario that can be presented to an enterprise, according to some examples of the present disclosure;

FIG. 3 illustrates a flowchart of an example method of inferring an explanation of an ML model output to a scenario, according to some examples of the present disclosure;

FIG. 4 illustrates a flowchart of an example method of inferring, by an LLM, an output for a scenario and an explanation of the output based on data associated with an ML model previously used to predict an output for the scenario, according to some examples of the present disclosure;

FIG. 5 illustrates a flowchart of an example method of generating a prompt for inferring an explanation of an ML model output for a scenario, according to some examples of the present disclosure;

FIG. 6 is an example of a deep learning neural network that can be used to implement all or a portion of the systems and techniques described herein, according to some examples of the present disclosure;

FIG. 7 is a diagram illustrating an example architecture of an example transformer model, according to some examples of the present disclosure; and

FIG. 8 illustrates an example processor-based system with which some embodiments of the subject technology can be implemented, according to some examples of the present disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

As discussed previously, an entity may use a machine learning model to gain insights and predictions about different scenarios. However, the output of this machine learning model can be in a form that is difficult for an entity to interpret. Further, the output of this machine learning model can lack information from which the entity can gather meaningful insight. For example, a machine learning model can be applied to identify specific risk levels associated with change requests made by an enterprise, e.g., as part of change management. As follows, the specific risk levels can be presented to the enterprise without any context associated with the risk levels or information describing the circumstances that led to the classification at the specific risk levels.

The disclosed technology addresses the foregoing by applying an LLM to infer an explanation of an output of a machine learning model. In turn, the output and the explanation of the output can be presented to an entity. The explanation of the output can be used by the entity to interpret the output and gain meaningful insights into the meaning of the output. The machine learning model can infer the output based on application of the machine learning model to input of a scenario. As follows, the LLM can infer the explanation of the output based on the input of the scenario, the output, one or more variables associated with the machine learning model inferring the output, or a combination thereof.

In various embodiments, the LLM can infer both an output and an explanation of the output. Specifically, a machine learning model can be applied to input of a scenario to infer a first output associated with the scenario. As follows, the LLM can infer both a second output associated with the scenario and an explanation of the inferred output. The LLM can infer either or both the second output and the explanation of the inferred output based on the input of the scenario, the first output inferred by the machine learning model, one or more variables associated with the machine learning model inferring the first output, or a combination thereof.

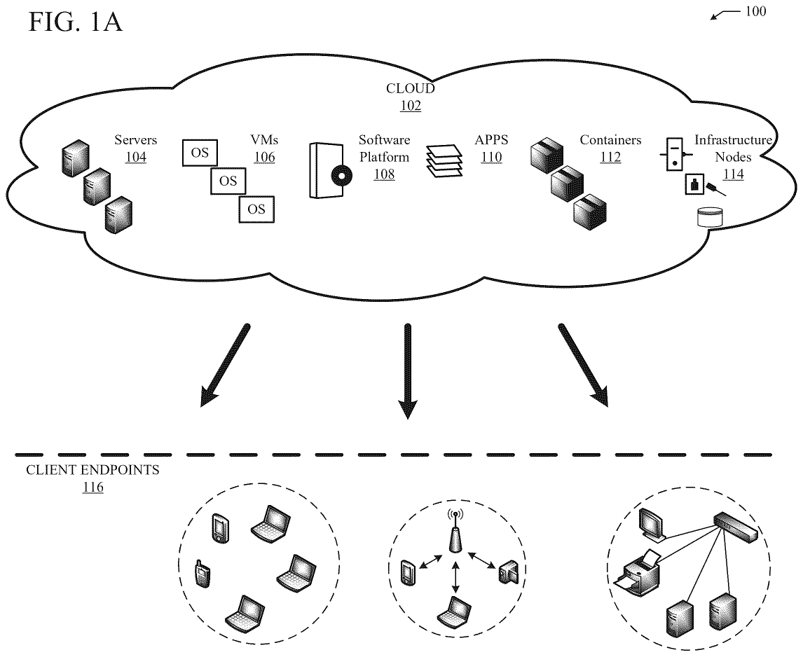

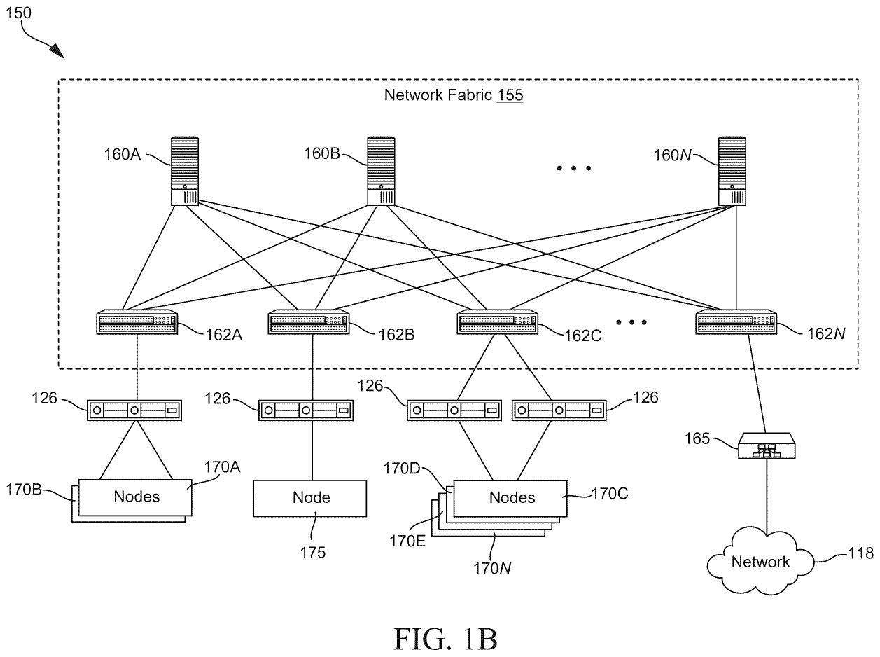

FIG. 1A illustrates a diagram of an example cloud computing architecture 100. The architecture can include a cloud 102. The cloud 102 can include one or more private clouds, public clouds, and/or hybrid clouds. Moreover, the cloud 102 can include cloud elements 104-114. The cloud elements 104-114 can include, for example, servers 104, virtual machines (VMs) 106, one or more software platforms 108, applications or services 110, software containers 112, and infrastructure nodes 114. The infrastructure nodes 114 can include various types of nodes, such as compute nodes, storage nodes, network nodes, management systems, etc.

The cloud 102 can provide various cloud computing services via the cloud elements 104-114, such as software as a service (SaaS) (e.g., collaboration services, email services, enterprise resource planning services, content services, communication services, etc.), infrastructure as a service (IaaS) (e.g., security services, networking services, systems management services, etc.), platform as a service (PaaS) (e.g., web services, streaming services, application development services, etc.), and other types of services such as desktop as a service (DaaS), information technology management as a service (ITaaS), managed software as a service (MSaaS), mobile backend as a service (MBaaS), etc.

The client endpoints 116 can connect with the cloud 102 to obtain one or more specific services from the cloud 102. The client endpoints 116 can communicate with elements 104-114 via one or more public networks (e.g., Internet), private networks, and/or hybrid networks (e.g., virtual private network). The client endpoints 116 can include any device with networking capabilities, such as a laptop computer, a tablet computer, a server, a desktop computer, a smartphone, a network device (e.g., an access point, a router, a switch, etc.), a smart television, a smart car, a sensor, a GPS device, a game system, a smart wearable object (e.g., smartwatch, etc.), a consumer object (e.g., Internet refrigerator, smart lighting system, etc.), a city or transportation system (e.g., traffic control, toll collection system, etc.), an internet of things (IoT) device, a camera, a network printer, or any smart or connected object (e.g., smart home, smart building, smart retail, smart glasses, etc.), and so forth.

In some cases, one or more embodiments, components, devices, nodes, systems, instances, and/or portions of the example cloud 102 can be implemented by and/or in a cloud network or datacenter. For example, any portion (or all) of the network 118, any of the content servers 120 (or all), and/or any of the system servers 126 (or all) can be implemented by and/or in a cloud network or datacenter. An example network architecture that can be used to implement any such network or datacenter (or any portion thereof), is shown in FIG. 1B and further described below.

FIG. 1B is a block diagram illustrating an example network architecture 150 that can be used to implement one or more embodiments, components, devices, nodes, systems, instances, and/or portions of the example cloud computing architecture 100, according to some examples of the present disclosure. The example network architecture 150 in FIG. 1B can represent, implement, deploy, host, support, include and/or provide the infrastructure for (or a portion of the infrastructure for) a datacenter (e.g., a cloud datacenter, an on-premises datacenter, a hybrid datacenter including private and public datacenters or datacenter portions, etc.), a network infrastructure, and/or any network environment (or portion thereof) such as, for example and without limitation, a cloud network/environment, a campus network/environment, an enterprise network/environment, an on-premises network/environment, a private network/environment, a public network/environment, a hybrid network/environment (e.g., a network/environment including both private and public networks/environments or portions thereof), and/or the like.

In some examples, the example network architecture 150 can host, implement, deploy, provide (e.g., provide the infrastructure for or a portion of the infrastructure for), support, and/or run/execute one or more applications, virtual machines (VMs), software containers, software tools, software functions, software algorithms, software models (e.g., artificial intelligence and machine learning models, software models implementing one or more classical algorithms, etc.), software applications, software packages, domains, databases, networks, services, workloads, service chains, functions, controllers, virtual network functions (VNFs), servers, drivers, hardware and/or software resources, software and/or hardware devices, software and/or hardware nodes, networking elements, serverless environments, serverless functions, cloud services and/or applications (e.g., software-as-a-service, function-as-a-service, infrastructure-as-a-service, platform-as-a-service, cloud applications, and/or any other cloud services and/or applications), execution environments, storage systems, processing/compute systems, memory systems, software and/or network sites, software policies, virtual/logical networks, overlay networks, software-defined networks (SDNs), interfaces, and/or any other code, component, element, application, service, etc.

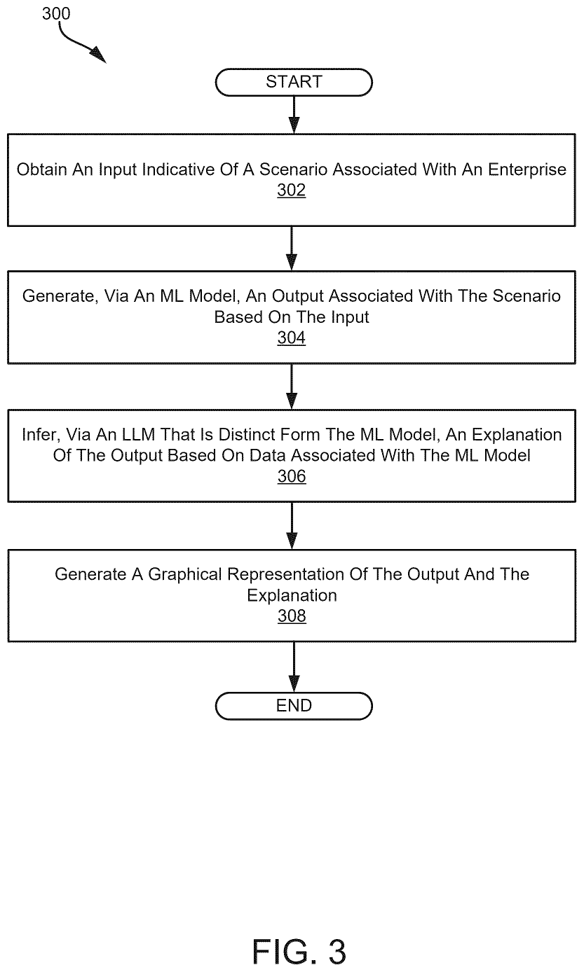

For example, the network architecture 150 can include, represent, implement, support, run, host, and/or provide the infrastructure for (or a portion of the infrastructure for) a datacenter, network (e.g., a cloud or cloud network, an on-premises network, a private network, a public network, a hybrid network, etc.), network infrastructure, and/or network environment used to host, implement, support, deploy, provide, and/or run quality control workloads/nodes, such as the worker nodes and the master node shown in FIG. 3 (and further described below). In such examples, the master node and each of the worker nodes can implement, include, represent, support, run, host, and/or provide one or more software applications/services, software systems, software packages, software modules, software units, software tools, interfaces, software/application code, functions, virtual environments, virtual applications, execution environments, virtualization elements (e.g., operating system-level virtualization elements, application-level virtualization elements, etc.), platforms, and/or any other components. In some cases, the master node and/or one or more of the worker nodes (or all) can each host and run one or more software containers, VMs, VNFs, applications (e.g., container applications, VM applications, and/or any other software applications), operating systems (OSs), functions, tools, and/or any other execution environment, code, tool, component, element, and/or package.

As shown in FIG. 1B, the network architecture 150 can include a network fabric 155. The network fabric 155 can include and/or represent the physical layer (e.g., underlay) and/or infrastructure of the network architecture 150. In some cases, the network fabric 155 can represent a data center(s) of one or more networks such as, for example, one or more cloud networks. The network fabric 155 can include network devices 160A-N (collectively referred to as “network devices 160” hereinafter) and network devices 162A-N (collectively referred to as “network devices 162” hereinafter), which are interconnected to route, relay, forward, and/or switch traffic in the network fabric 155. In some examples, the network devices 160 and the network devices 162 can include, implement, represent, and/or operate as switches (e.g., Layer 2 and/or Layer 3 switches, aggregation switches, ingress and/or egress switches, top-of-rack (ToR) switches, core switches, spine switches, leaf switches, etc.), routers, hubs, bridges, gateways, provider edge devices, firewalls, network controllers, and/or any other type of networking devices. In FIG. 1B, the network fabric 155 includes or implements a spine-leaf topology. In such examples, the network devices 160 can represent spine nodes (e.g., spine switches or routers) and the network devices 162 can represent leaf nodes (e.g., leaf switches or routers). In other examples, the network fabric 155 can alternatively or additionally include or implement any other network topology.

The network devices 160 are interconnected with the network devices 162, and the network devices 162 can connect the network 118, the system servers 126 (e.g., including QC system(s) 130 and configuration system(s) 132), the network device 165, the nodes 170, and/or the node 175 with any portion of the network fabric 155 (e.g., including each other), the media device(s) 106, the content servers 120, an external network(s), a network overlay(s), a logical network(s), a network portion(s) or branch/branches, an external device(s), a service chain(s), a data center(s), a cloud network(s), and/or any other network(s) and/or compute/network element(s). In some cases, the network fabric 155 can include, host, and/or implement a network overlay(s) or logical network(s) that includes or implements one or more application services, servers, VMs, software containers, virtual resources (e.g., storage, memory, processors, network interfaces, virtual tools, execution environments, etc.), workloads, functions, virtual networks, hardware and/or software resources, and/or any other element(s).

Network connectivity in the network fabric 155 can flow from the network devices 160 to the network devices 162, and vice versa. The network devices 162 can route, switch, relay, forward, and/or bridge network traffic to and from other portions of the network fabric 155, other networks, e.g. network 118, various network elements, the network device 165, the nodes 170, the node 175, external client devices (e.g., clients devices external to the network fabric 155), data centers, clouds, tunnels, software-defined networks (SDNs) and/or SDN branches, on-premises networks, cloud tenants, cloud customers, applications, and/or any other network element. Thus, the network devices 162 can connect networks and network elements of the network fabric 155 with each other and with other networks and network elements.

In FIG. 1B, the system servers 126 can include or represent computer servers. Each of the system servers 126 can host, include, implement, and/or run one or more applications, functions, services, VMs, software containers, service chains, workloads, AI/ML models, algorithms, resources, cloud appliances, and/or any other software. In some cases, the system servers 126 connected to the network devices 162 can encapsulate and decapsulate packets to and from the network devices 162. For example, the system servers 126 can include, host, implement and/or operate one or more virtual routers, switches, gateways, endpoints, and/or network devices for tunneling packets between an overlay or logical layer hosted by, or connected to, the system servers 126 and an underlay layer represented by or included in the network fabric 155.

As shown in FIG. 1B, the system servers 126 can host, include, run, operate, and/or implement the nodes 170 and the node 175. In some examples, the nodes 170 and the node 175 can represent cloud instances. For example, in some cases, the nodes 170 and the node 175 can each represent a virtual server and/or environment (e.g., a VM, a software container, etc.) that uses compute, memory, storage, and/or networking resources on the cloud (e.g., network architecture 150) for respective workloads. In some embodiments, the nodes 170 and/or the node 175 can perform parallel computing using, for example, multithreading. Each of the nodes 170 and/or the node 175 can include, host, implement, run, operate, and/or represent one or more server applications, software containers, VMs, software, services, AI/ML models, algorithms, cloud appliances, software functions, service chains, workloads, server-side functions, processing resources, computers, and/or any other software and/or hardware component.

For example, in some cases, each of the nodes 170 and/or the node 175 can represent a node instance that includes, implements, hosts, and/or runs a software container(s). The software container associated with a node can provide, run, deploy, include, operate, represent, and/or implement an execution environment(s), a workload(s), an application(s), software, an AI/ML model(s), an algorithm(s), a driver(s), a computer service(s), a software model(s) and/or algorithm(s), a function(s), a software library/libraries, a software tool(s), a software/cloud appliance(s), a software component(s), and/or any other computing element(s). In some cases, the nodes 170 and the node 175 can represent cloud node instances running respective computing environments, such as software containers or VMs. Each VM can include software, services, drivers, applications, libraries, functions, virtualized resources (e.g., processors, memory, storage, network interfaces, etc.), and/or workloads installed, implemented, included, and/or running/executed on a guest operating system (OS) associated with the VM.

The network architecture 150 can deploy, run, implement, host, and/or support various resources (e.g., hosts, applications, services, functions, VMs, software containers, workloads, cloud appliances, service chains, hardware and/or software resources, AI/ML models, algorithms, application platforms, operating systems, etc.) using the system servers 126, the network fabric 155, the network devices 160, the network devices 162, the network device 165, the nodes 170, the node 175, and the network 118.

In some cases, the network architecture 150 can implement and/or can be part of one or more cloud networks and can provide one or more cloud computing services such as, for example and without limitation, cloud storage, serverless computing, software-as-a-service (SaaS) (e.g., streaming services, content delivery services, video services, Internet content services, application services, conferencing services, etc.), infrastructure-as-a-service (IaaS), platform-as-a-service (PaaS) (e.g., web services, streaming services, content delivery services, content library services, conferencing services, video services, Internet content services, sharing and/or collaboration services, etc.), function-as-a-service (FaaS), and/or any other types of services such as desktop-as-a-service (DaaS), information technology management-as-a-service (ITaaS), managed software-as-a-service (MSaaS), mobile backend-as-a-service (MBaaS), etc.

The network architecture 150 described above illustrates a non-limiting example network architecture provided herein for explanation purposes. It should be noted that other network architectures can be implemented in other examples and are also contemplated herein. One of ordinary skill in the relevant art(s) will recognize in view of the disclosure that other network architectures can be used to implement one or more of the concepts, systems, techniques, devices, software, applications, methods, embodiments, elements, examples, and/or components disclosed herein.

Various embodiments of the subject technology can be implemented through the cloud computing architecture 100 shown in FIG. 1A and the network architecture 150 shown in FIG. 1B. In particular, ML models and LLMs and other applicable models and applications can be implemented through the architectures 100 and 150. Further graphical user interfaces (GUIs) implementing the technology described herein can be generated and displayed through the architectures 100 and 150.

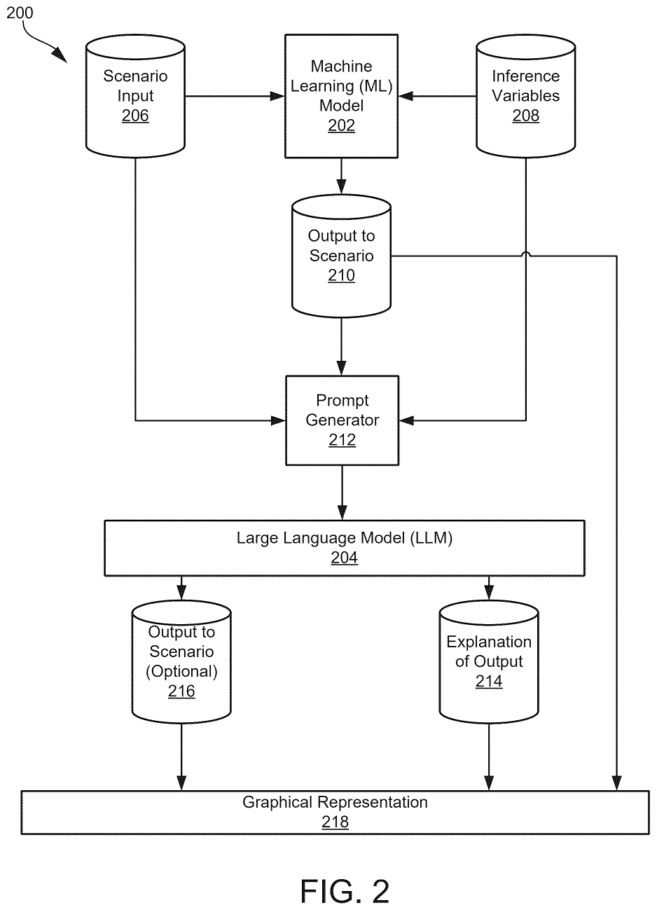

FIG. 2 illustrates a schematic diagram of an architecture 200 for inferring an explanation of an ML model output to a scenario that can be presented to an enterprise, according to some examples of the present disclosure. The architecture 200 comprises an ML model 202. The ML model 202 can be an applicable ML model that is trained to make classifications, predictions, or decisions based on input data. For example, the ML model 202 can be a classifier model that categorizes data into data groups based on features of the data, e.g. in relation to variables as will be discussed in greater detail later. In another example, the ML model 202 can be a classifier model that classifies data for an enterprise based on category. In yet another example, the ML model 202 can be a classifier model that scores urgency or risk of changes associated with a scenario.

The architecture 200 also comprises an LLM 204. The LLM 204 can be an applicable generative artificial intelligence (AI) model that can receive a prompt and make an inference based on the prompt. Specifically, the LLM 204 can perform natural language processing tasks based on a prompt to generate an inference. More specifically, the LLM 204, as will be discussed in greater detail later, can infer an explanation of an output of the ML model 202. In turn, this explanation can be presented to an entity for providing context about an output of the ML model 202 or otherwise provide a description of the output of the ML model 202. For example, the ML model 202 can generate a risk assessment for an enterprise in response to proposed changed requests. As follows, the LLM 204 can infer an explanation, e.g. in a natural language, of the risk assessment that can facilitate understanding of the risk assessment by a human user.

In various embodiments, the LLM 204 can infer an output similar to the ML model 202. Specifically, the LLM 204 can function as a classifier model and analyze input data to infer an output. For example, the LLM 204 can infer a risk assessment of a scenario based on input data for the scenario. In inferring the output for a scenario, the LLM 204 can also infer an explanation of the output. This explanation can be used to describe either or both the output inferred by the LLM or output that is generated by another model, e.g. the ML model 202.

In the architecture 200 shown in FIG. 2, the ML model 202 accesses scenario input 206 and inference variables 208 to infer an output to the scenario 210. Scenario input includes applicable information, otherwise data, that can be used in inferring an output for the scenario. A scenario can include one or more events, circumstances, or cases that can either or both be classified and the subject of a prediction or a decision. A scenario can be associated with an enterprise or an individual. Specifically, a scenario can include customer data that can be classified for various purposes. Examples of such purposes can include categorizing the scenario for understanding user intent associated with the scenario, assigning the scenario to an appropriate entity, and scoring the urgency or risk associated with the scenario. A scenario can be associated with change management. For example, a scenario can include one or more change requests that are made by an entity. The ML model 202 can infer a risk associated with implementing the change requests.

The inference variables 208 can include applicable variables that are analyzed by the ML model 202 to infer the output to the scenario 210. Specifically, the inference variables 208 can include variables that are used by the ML model 202 to infer the output to the scenario 210 based on the scenario input 206. More specifically, the inference variables 208 can include variables that are used by the ML model 202 to make a prediction about the scenario or classify the scenario based on the scenario input 206. For example, the inference variables 208 can include variables that are used in inferring a risk assessment for change requests as part of change management.

The inference variables 208 can comprise subjective variables. Subjective variables can comprise applicable variables that are specified, or otherwise defined, by a human associated with a scenario, e.g. a human associated with an enterprise, otherwise an enterprise. Such variables can pertain to an opinion of a person, e.g. as opposed to a fact, For example, subjective variables can comprise risk assessments provided by a risk assessor of an enterprise for defined scenarios. In identifying subjective variables, input from an enterprise or entity can be gathered and used to define the subjective variables. For example, an enterprise can be queried about certain factors and provide answers to the questions. In turn, the questions and answers provided by the enterprise can be used to define subjective variables for the enterprise. For example and with respect to change requests, a change requestor can be queried with questions to solicit answers as to how change requests will affect an enterprise. In turn, the change requestor can provide a subjective assessment that comprises likelihoods of certain events occurring in response to the change requests and the risks associated with such events. This subjective assessment can form the basis of subjective variables that can be used in performing a risk analysis for the scenario.

Additionally, the inference variables 208 can comprise objective variables. Objective variables can comprise applicable variables that are defined by a machine, e.g. associated with an enterprise or entity. Specifically, objective variables can be defined by rules or through AI, e.g. generative AI, otherwise not by a human. Such rules can be defined by the machine of an enterprise or an entity providing services for data management, e.g. change management. For example, an an objective variable can include a rule of whether a change impacts critical information technology equipment as a rule for predicting change risk. Further, objective variables can be defined from semantics of words, phrases, and sentences, otherwise elements of a natural language. For example, the question of whether a backout plan is detailed is an objective variable that can be identified from elements of a natural language description of predicting change risk by a generative AI model.

Further, the inference variables 208 can comprise historical variables. Historic variables can be defined by previous scenarios and outcomes associated with the previous scenarios. Specifically, historic variables can include scenarios that share similarities with a current scenario and have different outcomes from the current scenario. For example, historic variables can include similar change request scenarios where failure was not observed and similar change request scenarios where failure was observed. Further in the example, the historical scenarios can include predicted risks associated with the scenarios and whether the predicted risks were or were not realized.

The inference variables 208 can also comprise variables that are identifiable from, or otherwise associated with the scenario input 206 itself. Specifically, variables can include characteristics of the scenario that are identifiable from the scenario input 206. The characteristics can be identified from words, phrases, and sentences, otherwise elements of a natural language description of the scenario. For example, the variables can include attributes that are included in the description of change requests. Such attributes can be common across change requests for different entities. Further, variables that are identifiable from the scenario input 206 can be specific to an enterprise associated with the scenario. For example, the scenario input 206 can include customer-specific fields that are defined by the enterprise and are unique to the enterprise. In turn, these fields can be used to identify variables for the scenario, either through interpretation of the values of the fields or from the semantics of the elements of the fields.

The inference variables 208 can be interpretable by the LLM 204 in generating an inference. Specifically, the inference variables can be in a natural language that the LLM 204 can interpret in inferring either or both an output to the scenario 216 and an explanation of the output to the scenario 214. For example, the inference variables can include fields that are populated by a client in a natural language. In another example, the inference variable can include a natural language description of results of historical scenarios.

The architecture 200 includes a prompt generator 212. The prompt generator 212 functions to generate prompts for instructing the LLM 204. Specifically, the prompt generator 212 functions to generate prompts for instructing the LLM 204 to infer either or both the output to the scenario 216 and an explanation of the output of the scenario 214. The explanation of the output 214 generated by the LLM 204 can include an explanation of the output to the scenario 210 that is generated by the ML model 202. Further, the explanation of the output 214 generated by the LLM 204 can include an explanation of the output to the scenario 216 that is generated by the LLM 204 itself. Accordingly, the prompt generator 212 can generate a prompt that instructs the LLM 204 to generate an explanation for output that is generated by the LLM 204 itself or for output that is generate by another model, i.e. ML model 202.

The prompt generator 212 can use data associated with the ML model 202 to generate a prompt for the LLM 204. Data associated with the ML model 202 can include applicable data related to the ML model inferring the output to the scenario 210. Specifically, the scenario input 206, the inference variables 208, and the output to the scenario 210 can be fed to the prompt generator 212. As follows, the prompt generator 212 can generate a prompt based on the scenario input 206, the inference variables 208, e.g. used in generating the output to the scenario 210, the output to the scenario 210, or a combination thereof. For example, the prompt generator 212 can generate a prompt that excludes the scenario input 206, the inference variables 208, e.g. used in generating the output to the scenario 210, the output to the scenario 210, or a combination thereof. Similarly, the prompt generator 212 can generate a prompt that includes the scenario input 206, the inference variables 208, e.g. used in generating the output to the scenario 210, the output to the scenario 210, or a combination thereof.

In various embodiments, the prompt generator 212 can generate a prompt instructing the LLM 204 to generate an explanation of the output to the scenario 210 based on the way the ML model generated the output to the scenario 210. Specifically, the prompt generator can generate a prompt that comprises the output to the scenario 210 that is generated by the ML model 202 and the scenario input 206. The prompt can instruct the LLM 204 to infer an explanation of how the ML model 202 generated the output to the scenario 210 based on the scenario input 206. As follows, the LLM 204 can infer the explanation in response to the prompt and such inferred explanation can service as the explanation of the output 214f. In various embodiments, this inference can be made agnostic as to the specific inference variables 208 that are used by the ML model 202 to generate the output to the scenario 210. Accordingly, the prompt generator 212 can refrain from including the inference variables 208 that were used by the ML model 202 in the prompt for the LLM 204.

In various embodiments, the prompt generator 212 can generate a prompt instructing the LLM 204 to generate an inference of the output to the scenario 216 and an explanation of the output based on the inference. Specifically, the prompt generator 212 can generate a prompt instructing the LLM 204 to infer the output to the scenario 216 based on the scenario input 206 and the inference variables 208 that were used by the ML model 202. As follows, the prompt can instruct the LLM 204 to infer an explanation of the output to the scenario 216 that it generates based on the logic applied in inferring the output to the scenario 216. In various embodiments, this inference can be made agnostic as to the output to the scenario 210 that is generated by the ML model 202. Accordingly, the prompt generator 212 can refrain from including the output to the scenario 210 that is generated by the ML model 202 in the prompt for the LLM 204.

Data associated with the ML model can comprise weightings given by the ML model 202 to specific variables of the inference variables 208 in inferring the output to the scenario 210. The prompt generator 212 can use these weightings in generating prompts for the LLM 204. For example, the prompt generator 212 can generate a prompt specifying that the ML model 202 used the specific weights of the different inference variables 208 to infer the output to scenario 210. Further in the example, the prompt can specify to the LLM 204 to use the weights in inferring either or both the output to the scenario 216 and the explanation of the output 214.

The architecture 200 comprises a graphical representation 218, e.g. a graphical user interface (GUI), of an output to the scenario and an explanation of the output. Specifically, the graphical representation 218 can present either or both the output to the scenario 210 that is inferred by the ML model 202 and the output to the scenario 216 that is inferred by the LLM 204. Further, the graphical representation 218 can present the explanation of the output 214 that is inferred by the LLM 204. Either or both the output to the scenario and the explanation of the output 214 can be in a natural language form and the graphical representation 218 can present the output and the explanation of the output 214 in the natural language form. This facilitates easy interpretation of the presented information by a human associated with the enterprise.

FIG. 3 illustrates a flowchart 300 of an example method of inferring an explanation of an ML model output to a scenario, according to some examples of the present disclosure. The method shown in FIG. 3 is provided by way of example, as there are a variety of ways to carry out the method. Additionally, while the example method is illustrated with a particular order of steps, those of ordinary skill in the art will appreciate that FIG. 3 and the modules shown therein can be executed in any order and can include fewer or more modules than illustrated. Each module shown in FIG. 3 represents one or more steps, processes, methods or routines in the method. The modules will be discussed with respect to the example architectures described herein.

At module 302, input indicative of a scenario associated with an enterprise is obtained. The input can be received from the enterprise itself. Further the input can specify a specific classification, prediction, or other applicable inference that is wanted by the enterprise based on the input. For example, the input can specify change requests to make in an enterprise's infrastructure. Further in the example, the input can specify to determine a risk associated with the change requests.

At module 304, an output associated with the scenario is generated by the ML model 202 based on the input. The ML model 202 can generate the output based on inference variables and the scenario input. As discussed previously, output generated by ML models can be difficult to interpret, in particular by a human. Accordingly, it can be desirable for the output to have an associated description that describes what the output represents in a natural language and the circumstances describing why the ML model inferred the output.

The inference variables used by the ML model 202, as described previously, can be identified by the LLM 204. For example, the LLM 204 can define objective variables associated with an enterprise. Further in the example, the LLM 240 can be used to provide an explanation of an inference made by the ML model 202. Accordingly, the LLM 204 can be used multiple times in the method shown by the flowchart 300. Using the LLM 204 to infer variables that can then be used by the ML model 202 to generate an output is technically advantageous in that it provides more variables to the ML model 202 for generating the output. As follows, this can improve the functioning of the ML model 202 by allowing for the inference of more accurate output or an output that is associated with a greater amount of detail.

At module 306, an explanation of the output is inferred via the LLM 204 that is distinct from the ML model 202 based on data associated with the ML model 202. An explanation of output of a machine learning model, as used herein, can include applicable information describing the substance of the output, e.g. in a natural language. Further, an explanation of output of a machine learning model, as used herein, can include applicable information describing how and why the machine learning model inferred the output. For example, an explanation of the output of the ML model 202 can describe a risk level that was inferred by the ML model 202 and what factors led to the ML model 202 determining the specific risk level. Generating an explanation of an output of an ML model is technically advantageous as it can provide a user with a clearer understanding of the output of the model. Further, the explanation can itself provide more information to the user beyond just the output classification or prediction. In turn, this can facilitate more informed decision making by the user based on the output.

The LLM 204 can infer an explanation of the output from a prompt that is generated based on the input to the scenario, the output of the ML model 202 for the scenario, one or more inference variables associated with the ML model 202 inferring the output, weights assigned by the ML model 202 to the variables in inferring the output, or a combination thereof. Having the ability to generate a prompt for the LLM 204 with such a large amount of data can facilitate prompt diversity with respect to the information that can be included in the prompt. Such prompt diversity is technically advantageous, as it can facilitate more detailed prompts which allow the LLM 204 to generate an accurate and information rich explanation of the ML output. For example, instructions included in the prompt can be created with more specificity and clarity based on the ML input, the ML output, and the inference variables used to generate such output. As follows, the functioning of the LLM 204 can improve as the more detailed prompt can allow the LLM 204 to create a more accurate and information rich explanation. Further, such prompt diversity is technically advantageous as prompts can be tailored to specific customers or enterprises. In turn functioning of the LLM 204 can be improved with the ability to create an output explanation that is specific to different customers or enterprises, e.g. according to their requirements.

At module 308, a graphical representation of the output and the explanation of the output is generated. The graphical representation of the output of the ML model 202 and the explanation of the output, as generated by the LLM 204, can be presented in the same GUI or in separate GUIs. Further, the graphical representation of the output and the explanation of the output can be expressed in a natural language that is interpretable by a human. This is technically advantageous as it can help to ensure that a user understands the output and the explanation of the output.

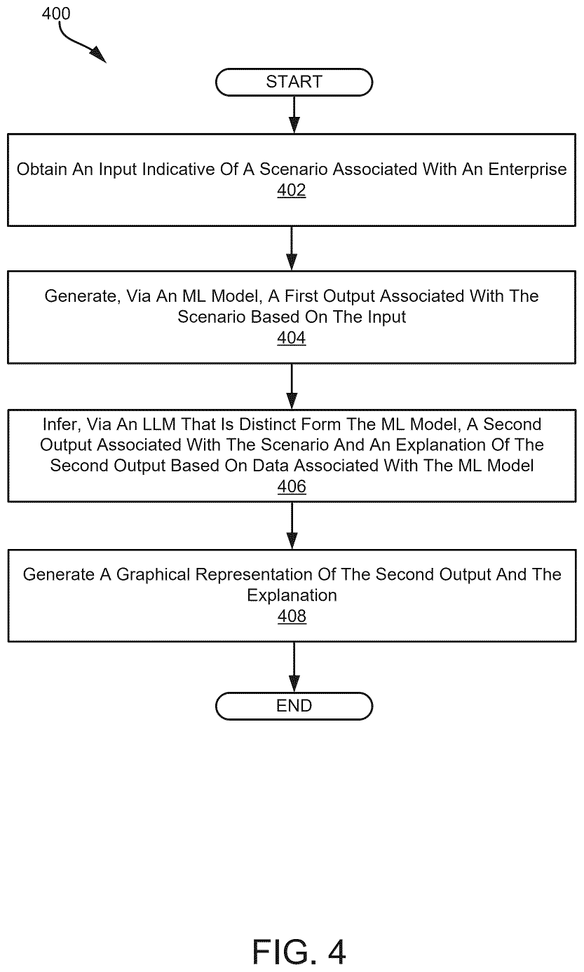

FIG. 4 illustrates a flowchart 400 of an example method of inferring by an LLM an output for a scenario and an explanation of the output based on data associated with an ML model previously used to predict an output for the scenario, according to some examples of the present disclosure. The method shown in FIG. 4 is provided by way of example, as there are a variety of ways to carry out the method. Additionally, while the example method is illustrated with a particular order of steps, those of ordinary skill in the art will appreciate that FIG. 4 and the modules shown therein can be executed in any order and can include fewer or more modules than illustrated. Each module shown in FIG. 4 represents one or more steps, processes, methods or routines in the method. The modules will be discussed with respect to the example architectures described herein.

At module 402, input indicative of a scenario associated with an enterprise is obtained. The input can be received from the enterprise itself. Further the input can identify a specific classification, prediction, or other applicable inference that is wanted by the enterprise based on the input. For example, the input can specify urgencies of different change requests to make in an enterprise's infrastructure. Further in the example, the input can specify to determine how the changes will affect the infrastructure based on different applied orders or urgency.

At module 404, a first output associated with the scenario is generated by the ML model 202 based on the input. The ML model 202 can generate the output based on inference variables and the scenario input. Such inference variables can include subjective variables, objective variables, and historical variables. Generating inferences based on an array of different variables, including both subjective and objective variables, is technically advantageous in that it can improve the accuracy of the ML model 202 in generating inferences. Further, generating inferences based on values that are specific to an enterprise is technically advantageous as the functioning of the ML model 202 can improve with the ability to generate inferences that are tailored to the enterprise, e.g. based on specific requirements of the enterprise.

At module 406, a second output associated with the scenario and an explanation of the second output is inferred via the LLM 204 based on data associated with the ML model 202. The LLM 204 is a distinct model from the ML model 202. In turn, the LLM 204 can generate an output that is distinct from the output that is generated by the ML model 202. This is technically advantageous as two different predictions are generated for the same scenario leading to the potential that a more accurate and information rich prediction has been generated. As follows, the outputs can be analyzed and one of them can be selected and presented, e.g. based on specific criteria. Alternatively, both outputs can be presented to provide diversity of predictions to a user. The LLM 204 can generate the explanation of the output for the scenario based on the output that it generates itself. In various embodiments, the LLM 204 can generate an explanation of the first output that is generated by the ML model 202 along with an explanation of the second output that is generated by the LLM 204 itself. In turn, both explanations along with both outputs can be presented to a user. This is technically advantageous as it provides diversity of predictions and explanations of the predictions to the user.

At module 408, a graphical representation of the second output and the explanation of the second output is generated. The graphical representation of the second output of the ML model LLM and the explanation of the second output, as generated by the LLM 204, can be presented in the same GUI or in separate GUIs. Further, the graphical representation of the second output and the explanation of the second output can be expressed in a natural language that is interpretable by a human. This is technically advantageous as it can help to ensure that a user understands the output of the LLM 204 and the explanation of the output.

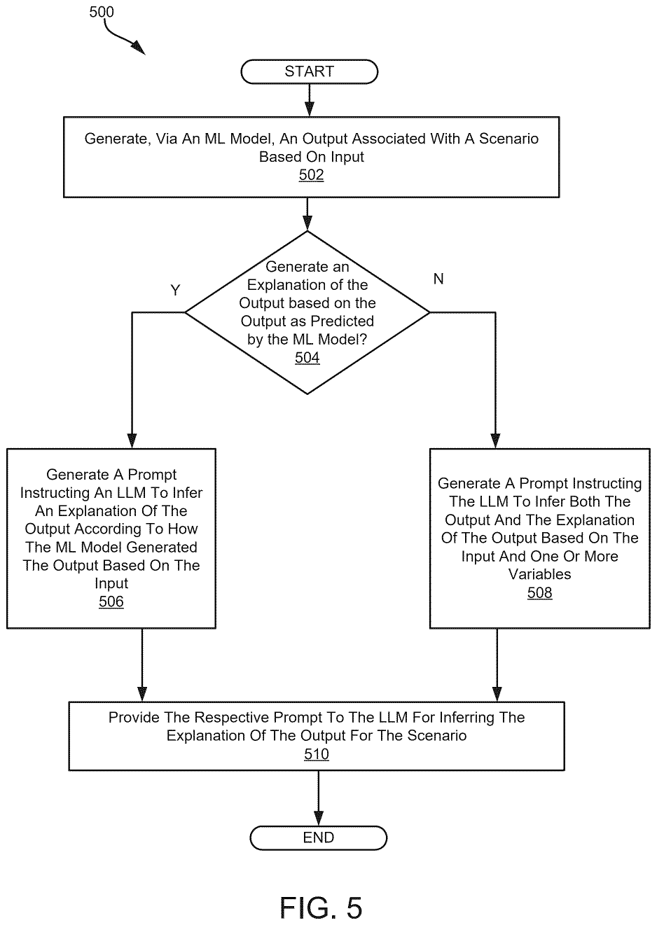

FIG. 5 illustrates a flowchart 500 of an example method of generating a prompt for inferring an explanation of an ML model output for a scenario, according to some examples of the present disclosure. The method shown in FIG. 5 is provided by way of example, as there are a variety of ways to carry out the method. Additionally, while the example method is illustrated with a particular order of steps, those of ordinary skill in the art will appreciate that FIG. 5 and the modules shown therein can be executed in any order and can include fewer or more modules than illustrated. Each module shown in FIG. 5 represents one or more steps, processes, methods or routines in the method. The modules will be discussed with respect to the example architectures described herein.

At module 502, an output associated with a scenario is generated, via the ML model 202, based on input associated with the scenario. The output can be used to generate an explanation of the output by the LLM 204. In various embodiments, the output can be provided to an LLM 204 and used by the LLM 204 to infer a separate output to the scenario.

At decision point 504, it is determined whether to generate an explanation of the output based on the output predicted by the ML model 202. If it is determined to generate the explanation of the output based on the output as predicted by the ML model 202, then the flowchart 500 continues to module 506. At module 506, a prompt is generated that instructs the LLM 204 to infer an explanation of the output according to how the ML model 202 generated the output based on the input. Specifically, the prompt can ask the LLM 204 to infer how the ML model 202 generated the output based on the input given the output and the input that is provided to the LLM 304. If it is determined to generate the explanation of the output agnostic to the output predicted by the ML model 202, then the flowchart 500 continues to module 508. At module 508, a prompt is generated that instructs the LLM 204 to infer both the output and the explanation of the output based on the input and one or more inference variables. Generating an explanation of an output of the ML model 202 based on the output itself and subsequently inferring an explanation with or without the output is technically advantageous in that it can provide diversity in explanations that can be presented to a user. In turn, either or both explanations can be presented to a user allowing them to further understand and make an informed decision based on the output of the ML model 202. Further, the scenario where the output itself is used by the LLM 204 in inferring an explanation improves the functioning of the LLM 204 as the LLM has more available data to use in generating the explanation, thereby facilitating inference of a more accurate and information rich explanation.

At module 510, the respective prompt is provided to the LLM 204 for inferring the explanation of the output for the scenario. Specifically, the LLM 204 can infer the explanation of the output for the scenario according to how the ML model 202 generate the output based on the input. Alternatively, the LLM 204 can infer the explanation of the output for the scenario according to the input to the scenario and the variables used by the ML model 202 to infer the output.

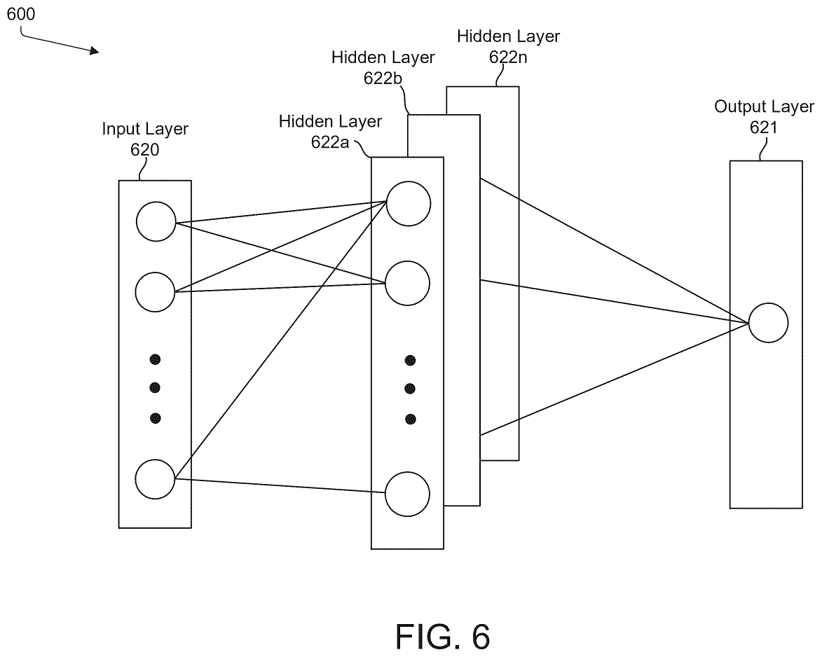

In FIG. 6, the disclosure now turns to a further discussion of models that can be used to implement the technology described herein. FIG. 6 is an example of a deep learning neural network 600 that can be used to implement all or a portion of the systems and techniques described herein, according to some examples of the present disclosure. An input layer 620 can be configured to receive sensor data and/or data relating to an environment surrounding an AV. Neural network 600 includes multiple hidden layers 622a, 622b, through 622n. The hidden layers 622a, 622b, through 622n include “n” number of hidden layers, where “n” is an integer greater than or equal to one. The number of hidden layers can be made to include as many layers as needed for the given application. Neural network 600 further includes an output layer 621 that provides an output resulting from the processing performed by the hidden layers 622a, 622b, through 622n.

Neural network 600 is a multi-layer neural network of interconnected nodes. Each node can represent a piece of information. Information associated with the nodes is shared among the different layers and each layer retains information as information is processed. In some cases, the neural network 600 can include a feed-forward network, in which case there are no feedback connections where outputs of the network are fed back into itself. In some cases, the neural network 600 can include a recurrent neural network, which can have loops that allow information to be carried across nodes while reading in input.

Information can be exchanged between nodes through node-to-node interconnections between the various layers. Nodes of the input layer 620 can activate a set of nodes in the first hidden layer 622a. For example, as shown, each of the input nodes of the input layer 620 is connected to each of the nodes of the first hidden layer 622a. The nodes of the first hidden layer 622a can transform the information of each input node by applying activation functions to the input node information. The information derived from the transformation can then be passed to and can activate the nodes of the next hidden layer 622b, which can perform their own designated functions. Example functions include convolutional, up-sampling, data transformation, and/or any other suitable functions. The output of the hidden layer 622b can then activate nodes of the next hidden layer, and so on. The output of the last hidden layer 622n can activate one or more nodes of the output layer 621, at which an output is provided. In some cases, while nodes in the neural network 600 are shown as having multiple output lines, a node can have a single output and all lines shown as being output from a node represent the same output value.

In some cases, each node or interconnection between nodes can have a weight that is a set of parameters derived from the training of the neural network 600. Once the neural network 600 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 600 to be adaptive to inputs and able to learn as more and more data is processed.

The neural network 600 is pre-trained to process the features from the data in the input layer 620 using the different hidden layers 622a, 622b, through 622n in order to provide the output through the output layer 621.

In some cases, the neural network 600 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 600 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(½(target-output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 600 can perform a backward pass by determining which inputs (weights) most contributed to the loss of the network, and can adjust the weights so that the loss decreases and is eventually minimized.

The neural network 600 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 600 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

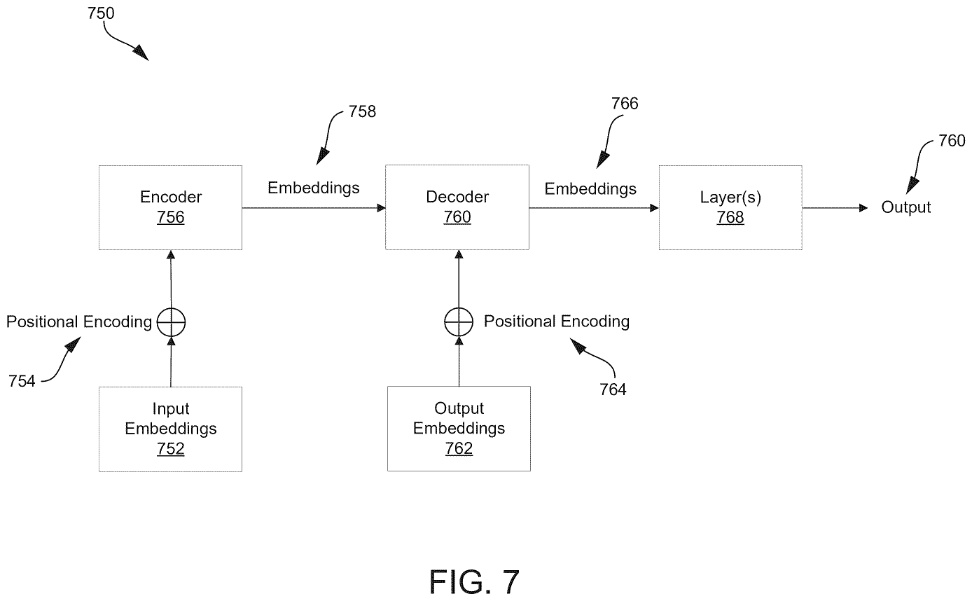

FIG. 7 is a diagram illustrating an example architecture of an example transformer model 750, according to some examples of the present disclosure. The transformer model 750 can be used to implement an LLM that can be used to implement the technology described herein. As shown, the transformer model 750 can include input embeddings 752 used as inputs to the transformer model 750. The input embeddings 752 can include input values representing words and/or sentences, such as numbers or vectors representing words and/or sentences.

In some cases, the input embeddings 752 can function like a dictionary that helps the transformer model 750 understand the meaning of words by placing them in an embedding space where similar words are located near each other. In some examples, the input interface 134 can be trained and/or configured to create the input embeddings 752 so that similar vectors represent words with similar meanings. In some examples, the transformer model 750 can additionally or alternatively learn to create and/or process the input embeddings 752 during training.

The transformer model 750 can use positional encoding 754 to encode the position of each word in an input sequence from the input embeddings 752 as values such as a set of numbers, a vector, etc. The values generated by the positional encoding 754 can be fed into the transformer model 750 along with the input embeddings 752. By incorporating the positional encoding 754 into the transformer model 750, the transformer model 750 can more effectively understand the order of words in a sentence and generate grammatically correct and semantically meaningful output.

The transformer model 750 can include an encoder(s) 756 used to process the positionally encoded input embeddings 752 and generate embeddings 758. The encoder(s) 756 can be part of the transformer model 750 that processes input text and generates hidden states that capture the meaning and context of the text. For example, the encoder(s) 756 can include a feed-forward neural network that is part of the transformer model 750. In some examples, the encoder(s) 756 can implement multiple encoder layers. In some cases, the encoder(s) 756 can first tokenize the input text into a sequence of tokens, such as individual words or subwords. The encoder(s) 756 can then apply one or more self-attention layers, which can generate hidden states that represent the input text at different levels of abstraction. In this way, the encoder(s) 756 can generate the embeddings 758 (e.g., a vector, a set of values, etc.) representing the semantics and position of words in one or more sentences.

The transformer model 750 can include output embeddings 762, which can include values representing words and/or sentences, such as numbers or vectors representing words and/or sentences. The output embeddings 762 can be similar to the input embeddings 752 and can also be processed by positional encoding 764 to encode the position of each word in a sequence from the output embeddings 762 as values such as a set of numbers, a vector, etc., which helps the transformer model 750 understand the order of words in a sentence. The output embeddings 762 can be used during a training phase of the transformer model 750 and can be used during an inference phase. During training, a loss function can be computed based on the output embeddings 762 and used to update the model parameters to improve the accuracy of the transformer model 750. During an inference phase, the output embeddings 762 can be used to generate the output text by mapping the predicted probabilities determined by the transformer model 750 for each token to the corresponding token in the vocabulary.

The positionally encoded input embeddings 752 (e.g., the embeddings 758) and the positionally encoded output embeddings 762 can be fed to a decoder(s) 760 used to generate the output sequence based on the encoded input sequence. During training, the decoder(s) 760 can learn how to guess the next word of a sequence by looking at the words before it. In some examples, the decoder(s) 760 can generate natural language text based on the input sequence and any learned context.

The decoder(s) 760 can generate embeddings 766 and feed the embeddings 766 to one or more network layers 768. In some examples, the one or more network layers 768 can include a linear layer and a softmax function. The linear layer can map the embeddings 766 generated by the decoder(s) 760 to a higher-dimensional space, which can transform the embeddings 766 into the original input space. The softmax function can then be applied to generate a probability distribution for each output token in the vocabulary, which can result in an output 770. In some examples, the output 770 can include output tokens with probabilities.

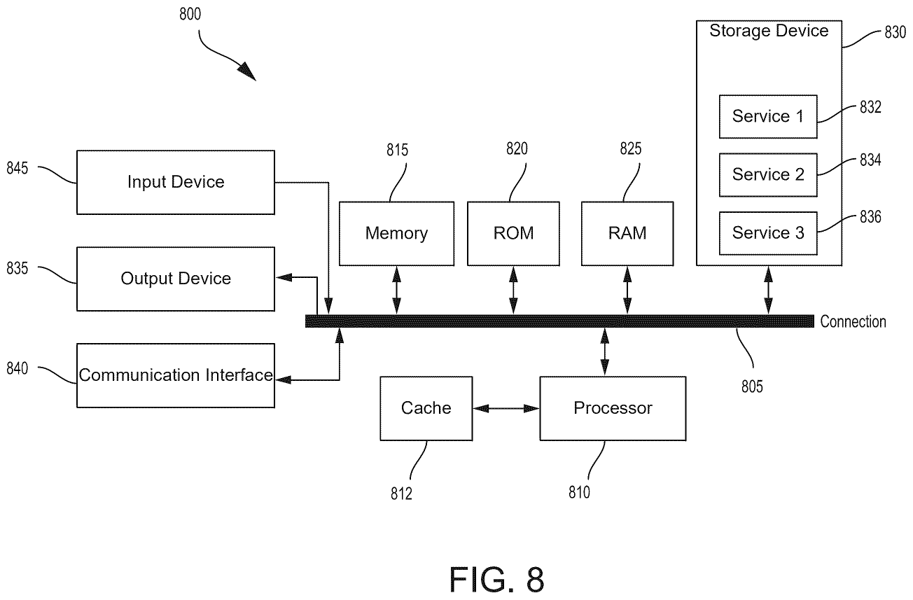

FIG. 8 illustrates an example processor-based system with which some embodiments of the subject technology can be implemented. For example, processor-based system 800 can be any computing device making up, or any component thereof in which the components of the system are in communication with each other using connection 805. Connection 805 can be a physical connection via a bus, or a direct connection into processor 810, such as in a chipset architecture. Connection 805 can also be a virtual connection, networked connection, or logical connection.

In some embodiments, computing system 800 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 800 includes at least one processing unit (Central Processing Unit (CPU) or processor) 810 and connection 805 that couples various system components including system memory 815, such as Read-Only Memory (ROM) 820 and Random-Access Memory (RAM) 825 to processor 810. Computing system 800 can include a cache of high-speed memory 812 connected directly with, in close proximity to, or integrated as part of processor 810.

Processor 810 can include any general-purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms known to those of skill in the art. In some instances, multimodal systems can enable a user to provide multiple types of input/output to communicate with computing system 800. Computing system 800 can include communications interface 840, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 840 may also include one or more Global Navigation Satellite System (GNSS) receivers or transceivers that are used to determine a location of the computing system 800 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 830 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 830 can include software services, servers, services, etc., that when the code that defines such software is executed by the processor 810, it causes the system 800 to perform a function. In some embodiments, a hardware service that performs a particular function can include the software component stored in a computer-readable medium in connection with the necessary hardware components, such as processor 810, connection 805, output device 835, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### SELECTED EXAMPLES

Illustrative examples of the disclosure include:

Embodiment 1. A computer-implemented method comprising: obtaining an input indicative of a scenario associated with an enterprise; generating, via a machine learning (ML) model, an output associated with the scenario based on the input; inferring, via a large language model (LLM) that is distinct from the ML model, an explanation of the output based on data associated with the ML model; and generating a graphical representation of the output and the explanation.

Embodiment 2. The computer-implemented method of Embodiment 1, further comprising: generating a prompt as part of the data associated with the ML model; and providing the prompt to the LLM to infer the explanation of the output.

Embodiment 3. The computer-implemented method of either of Embodiments 1 or 2, wherein the data associated with the ML model comprises the input of the scenario, the output, one or more variables associated with the ML model inferring the output, or a combination thereof.

Embodiment 4. The computer-implemented method of Embodiment 3, further comprising: generating a prompt as part of the data associated with the ML model, the prompt instructing the LLM to infer the explanation of the output according to how the ML model generated the output based on the input of the scenario; and providing the prompt as part of the data associated with the ML model to the LLM to infer the explanation of the output.

Embodiment 5. The computer-implemented method of either of Embodiments 3 or 4, further comprising: generating a prompt as part of the data associated with the ML model, the prompt instructing the LLM to infer the output for the scenario and the explanation of the output based on the input of the scenario and the one or more variables; and providing the prompt as part of the data associated with the ML model to the LLM to infer the explanation of the output.

Embodiment 6. The computer-implemented method of any of any of Embodiments 3 through 5, wherein the one or more variables comprise subjective variables, objective variables, historical variables, variables associated with the input itself, or a combination thereof.

Embodiment 7. The computer-implemented method of any of Embodiments 3 through 6, wherein the data associated with the ML model comprises weightings given to the one or more variables by the ML model in generating the output.

Embodiment 8. The computer-implemented method of any of Embodiments 3 through 7, wherein the one or more variables are interpretable by the LLM in generating an inference.

Embodiment 9. The computer-implemented method of any of Embodiments 1 through 8, wherein the ML model is a classifier and the output is a classification associated with the scenario.

Embodiment 10. The computer-implemented method of any of Embodiments 1 through 9, wherein the explanation of the output is in a natural language, the method further comprising presenting the graphical representation of the output and the explanation to the enterprise.

Embodiment 11. A system comprising: one or more processors; and at least one computer-readable storage medium having stored therein instructions which, when executed by the one or more processors, cause the one or more processors to: obtain an input indicative of a scenario associated with an enterprise; generate, via a machine learning (ML) model, an output associated with the scenario based on the input; infer, via a large language model (LLM) that is distinct from the ML model, an explanation of the output based on data associated with the ML model; and generate a graphical representation of the output and the explanation.

Embodiment 12. The system of Embodiment 11, wherein the instruction further cause the one or more processors to: generate a prompt as part of the data associated with the ML model; and provide the prompt to the LLM to infer the explanation of the output.

Embodiment 13. The system of either of Embodiments 11 or 12, wherein the data associated with the ML model comprises the input of the scenario, the output, one or more variables associated with the ML model inferring the output, or a combination thereof.

Embodiment 14. The system of Embodiment 13, wherein the instructions further cause the one or more processors to: generate a prompt as part of the data associated with the ML model, the prompt instructing the LLM to infer the explanation of the output according to how the ML model generated the output based on the input of the scenario; and provide the prompt as part of the data associated with the ML model to the LLM to infer the explanation of the output.

Embodiment 15. The system of either of Embodiments 13 or 14, wherein the instructions further cause the one or more processors to: generate a prompt as part of the data associated with the ML model, the prompt instructing the LLM to infer the output for the scenario and the explanation of the output based on the input of the scenario and the one or more variables; and provide the prompt as part of the data associated with the ML model to the LLM to infer the explanation of the output.

Embodiment 16. The system of any of Embodiments 13 through 15, wherein the one or more variables comprise subjective variables, objective variables, historical variables, variables associated with the input itself, or a combination thereof.

Embodiment 17. The system of any of Embodiments 13 through 16, wherein the data associated with the ML model comprises weightings given to the one or more variables by the ML model in generating the output.

Embodiment 18. The system of any of Embodiments 13 through 17, wherein the one or more variables are interpretable by the LLM in generating an inference.

Embodiment 19. The system of any of Embodiments 11 through 18, wherein the ML model is a classifier and the output is a classification associated with the scenario.

Embodiment 20. A non-transitory computer-readable storage medium storing instructions for causing one or more processors to: obtain an input indicative of a scenario associated with an enterprise; generate, via a machine learning (ML) model, an output associated with the scenario based on the input; infer, via a large language model (LLM) that is distinct from the ML model, an explanation of the output based on data associated with the ML model; and generate a graphical representation of the output and the explanation.

Embodiment 21. A computer-implemented method comprising: obtaining an input indicative of a scenario associated with an enterprise; generating, via a machine learning (ML) model, a first output associated with the scenario based on the input; inferring, via a large language model (LLM) that is distinct from the ML model, a second output of the scenario and an explanation of the second output based on data associated with the ML model; and generating a graphical representation of the second output and the explanation of the second output.

Embodiment 22. The computer-implemented method of Embodiment 21, further comprising: generating a prompt as part of the data associated with the ML model; and providing the prompt to the LLM to infer the second output and the explanation of the second output.

Embodiment 23. The computer-implemented method of either of Embodiments 21 or 22, wherein the data associated with the ML model comprises the input of the scenario, the output, one or more variables associated with the ML model inferring the output, or a combination thereof.

Embodiment 24. The computer-implemented method of Embodiment 23, further comprising: generating a prompt as part of the data associated with the ML model, the prompt instructing the LLM to infer the second output for the scenario and the explanation of the second output based on the input of the scenario and the one or more variables; and providing the prompt to the LLM to infer the second output and the explanation of the second output.

Embodiment 25. The computer-implemented method of Embodiment 24, wherein the prompt further instructs the LLM to infer the explanation of the second output based on the output of the ML model.

Embodiment 26. The computer-implemented method of any of any of Embodiments 23 through 25, wherein the one or more variables comprise subjective variables, objective variables, historical variables, variables associated with the input itself, or a combination thereof.

Embodiment 27. The computer-implemented method of any of Embodiments 23 through 26, wherein the data associated with the ML model comprises weightings given to the one or more variables by the ML model in generating the output.

Embodiment 28. The computer-implemented method of any of Embodiments 23 through 27, wherein the one or more variables are interpretable by the LLM in generating an inference.

Embodiment 29. The computer-implemented method of any of Embodiments 21 through 28, wherein the ML model is a classifier and the output is a classification associated with the scenario.

Embodiment 30. The computer-implemented method of any of Embodiments 21 through 29, wherein the explanation of the second output is in a natural language, the method further comprising presenting the graphical representation of the second output and the explanation to the enterprise.

Embodiment 31. A system comprising: one or more processors; and at least one computer-readable storage medium having stored therein instructions which, when executed by the one or more processors, cause the one or more processors to: obtain an input indicative of a scenario associated with an enterprise; generate, via a machine learning (ML) model, a first output associated with the scenario based on the input; infer, via a large language model (LLM) that is distinct from the ML model, a second output of the scenario and an explanation of the second output based on data associated with the ML model; and generate a graphical representation of the second output and the explanation of the second output.

Embodiment 32. The system of Embodiment 31, wherein the instruction further cause the one or more processors to: generate a prompt as part of the data associated with the ML model; and provide the prompt to the LLM to infer the second output and the explanation of the second output.

Embodiment 33. The system of either of Embodiments 31 or 32, wherein the data associated with the ML model comprises the input of the scenario, the output, one or more variables associated with the ML model inferring the output, or a combination thereof.

Embodiment 34. The system of Embodiment 33, wherein the instructions further cause the one or more processors to: generate a prompt as part of the data associated with the ML model, the prompt instructing the LLM to infer the second output for the scenario and the explanation of the second output based on the input of the scenario and the one or more variables; and provide the prompt to the LLM to infer the second output and the explanation of the second output.

Embodiment 35. The system of Embodiment 34, wherein the prompt further instructs the LLM to infer the explanation of the second output based on the output of the ML model.

Embodiment 36. The system of any of Embodiments 33 through 35, wherein the one or more variables comprise subjective variables, objective variables, historical variables, variables associated with the input itself, or a combination thereof.

Embodiment 37. The system of any of Embodiments 33 through 36, wherein the data associated with the ML model comprises weightings given to the one or more variables by the ML model in generating the output.

Embodiment 38. The system of any of Embodiments 33 through 37, wherein the one or more variables are interpretable by the LLM in generating an inference.

Embodiment 39. The system of any of Embodiments 31 through 38, wherein the ML model is a classifier and the output is a classification associated with the scenario.

Embodiment 40. A non-transitory computer-readable storage medium storing instructions for causing one or more processors to: obtain an input indicative of a scenario associated with an enterprise; generate, via a machine learning (ML) model, a first output associated with the scenario based on the input; infer, via a large language model (LLM) that is distinct from the ML model, a second output of the scenario and an explanation of the second output based on data associated with the ML model; and generate a graphical representation of the second output and the explanation of the second output.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A computer-implemented method comprising:
obtaining an input indicative of a scenario associated with an enterprise;
generating, via a machine learning (ML) model, an output associated with the scenario based on the input;
inferring, via a large language model (LLM) that is distinct from the ML model, an explanation of the output based on data associated with the ML model; and
generating a graphical representation of the output and the explanation.

2. The computer-implemented method of claim 1, further comprising:
generating a prompt as part of the data associated with the ML model; and
providing the prompt to the LLM to infer the explanation of the output.

3. The computer-implemented method of claim 1, wherein the data associated with the ML model comprises the input of the scenario, the output, one or more variables associated with the ML model inferring the output, or a combination thereof.

4. The computer-implemented method of claim 3, further comprising:
generating a prompt as part of the data associated with the ML model, the prompt instructing the LLM to infer the explanation of the output according to how the ML model generated the output based on the input of the scenario; and
providing the prompt as part of the data associated with the ML model to the LLM to infer the explanation of the output.

5. The computer-implemented method of claim 3, further comprising:
generating a prompt as part of the data associated with the ML model, the prompt instructing the LLM to infer the output for the scenario and the explanation of the output based on the input of the scenario and the one or more variables; and
providing the prompt as part of the data associated with the ML model to the LLM to infer the explanation of the output.

6. The computer-implemented method of claim 3, wherein the one or more variables comprise subjective variables, objective variables, historical variables, variables associated with the input itself, or a combination thereof.

7. The computer-implemented method of claim 3, wherein the data associated with the ML model comprises weightings given to the one or more variables by the ML model in generating the output.

8. The computer-implemented method of claim 3, wherein the one or more variables are interpretable by the LLM in generating an inference.

9. The computer-implemented method of claim 1, wherein the ML model is a classifier and the output is a classification associated with the scenario.

10. The computer-implemented method of claim 1, wherein the explanation of the output is in a natural language, the method further comprising presenting the graphical representation of the output and the explanation to the enterprise.

11. A system comprising:
one or more processors; and
at least one computer-readable storage medium having stored therein instructions which, when executed by the one or more processors, cause the one or more processors to:
obtain an input indicative of a scenario associated with an enterprise;
generate, via a machine learning (ML) model, an output associated with the scenario based on the input;
infer, via a large language model (LLM) that is distinct from the ML model, an explanation of the output based on data associated with the ML model; and
generate a graphical representation of the output and the explanation.

12. The system of claim 11, wherein the instruction further cause the one or more processors to:
generate a prompt as part of the data associated with the ML model; and
provide the prompt to the LLM to infer the explanation of the output.

13. The system of claim 11, wherein the data associated with the ML model comprises the input of the scenario, the output, one or more variables associated with the ML model inferring the output, or a combination thereof.

14. The system of claim 13, wherein the instructions further cause the one or more processors to:
generate a prompt as part of the data associated with the ML model, the prompt instructing the LLM to infer the explanation of the output according to how the ML model generated the output based on the input of the scenario; and
provide the prompt as part of the data associated with the ML model to the LLM to infer the explanation of the output.

15. The system of claim 13, wherein the instructions further cause the one or more processors to:
generate a prompt as part of the data associated with the ML model, the prompt instructing the LLM to infer the output for the scenario and the explanation of the output based on the input of the scenario and the one or more variables; and
provide the prompt as part of the data associated with the ML model to the LLM to infer the explanation of the output.

16. The system of claim 13, wherein the one or more variables comprise subjective variables, objective variables, historical variables, variables associated with the input itself, or a combination thereof.

17. The system of claim 13, wherein the data associated with the ML model comprises weightings given to the one or more variables by the ML model in generating the output.

18. The system of claim 13, wherein the one or more variables are interpretable by the LLM in generating an inference.

19. The system of claim 11, wherein the ML model is a classifier and the output is a classification associated with the scenario.

20. A non-transitory computer-readable storage medium storing instructions for causing one or more processors to:
obtain an input indicative of a scenario associated with an enterprise;
generate, via a machine learning (ML) model, an output associated with the scenario based on the input;
infer, via a large language model (LLM) that is distinct from the ML model, an explanation of the output based on data associated with the ML model; and
generate a graphical representation of the output and the explanation.
